(19) United States
(12) Patent Application Publication
(10) Pub. No.: US 2025/0153809 A1
(43) Pub. Date: May 15, 2025

(54) SPINDLE ASSEMBLY FOR A SNOW VEHICLE

(71) Applicant: Polaris Industries Inc., Medina, MN (US)

(72) Inventors: Cody Telford, Sandpoint, ID (US); David Christian, Wyoming, MN (US); Jimmy D. Brooks, Sandpoint, ID (US)

(21) Appl. No.: 18/937,839

(22) Filed: Nov. 5, 2024

Related U.S. Application Data
(60) Provisional application No. 63/597,798, filed on Nov. 10, 2023.

(51) Int. Cl. B62M 27/02

(52) U.S. Cl. CPC B62M 27/02; B62M 2027/021; B62M 2027/026

(57) ABSTRACT

A snow vehicle is provided comprising a ground engaging member and a frame supported by the ground engaging member. A steering assembly is coupled between the frame and the ground engaging member, and a spindle assembly is coupled between the ground engaging member and the steering assembly. The spindle assembly comprises a first portion coupled to the ground engaging member, and a second portion coupled to the steering assembly, and the first portion is removably coupled to the second portion.

### CROSS-REFERENCE TO RELATED APPLICATION PAPERS

The present application claims priority to U.S. Provisional Patent Application Ser. No. 63/597,798, filed Nov. 10, 2023, the disclosure of which is incorporated herein by reference.

### FIELD OF THE DISCLOSURE

The present disclosure relates to a steering assembly of a snow vehicle.

### BACKGROUND OF THE DISCLOSURE

Snow bikes are used in trail and off-trail conditions and require mounting solutions for coupling a ski to an existing fork assembly. Mounting solutions are subject to large forces and there is a need for methods of easily maintaining and replacing components.

### SUMMARY OF THE DISCLOSURE

In an embodiment of the present disclosure, a snow vehicle is provided. The snow vehicle comprises a ground engaging member and a frame supported by the ground engaging member. The snow vehicle further comprises a steering assembly coupled between the frame and the ground engaging member, and a spindle assembly coupled between the ground engaging member and the steering assembly. The spindle assembly comprises a first portion coupled to the ground engaging member and a second portion coupled to the steering assembly, and the first portion is removably coupled to the second portion.

In embodiments, the first portion comprises a front frame member and a rear frame member and the second portion comprises a mounting portion extending between the front frame member and the rear frame member.

In embodiments, a first interface between the front frame member of the first portion and the mounting portion of the second portion extends along a first plane, and a second interface between the rear frame member of the first portion and the mounting portion of the second portion extends along a second plane and the first plane and the second plane are non-parallel.

In embodiments, a first fastener extends through the first interface in a generally longitudinal direction of the snow vehicle and a second fastener extends through the second interface in a generally longitudinal direction of the snow vehicle.

In embodiments, the front frame member of the first portion comprises a first bend portion and an intermediate frame member extending between the first bend portion and the rear frame member of the first portion.

In embodiments, the rear frame member of the first portion comprises a second bend portion positioned vertically lower than the intermediate frame member.

In embodiments, the second portion comprises a plurality of apertures, and a collar is configured to couple between the steering assembly and the second portion at the plurality of apertures.

In embodiments, the plurality of apertures includes a first aperture and a channel, wherein the collar is configured to be fixed relative to the first apertures and movable within the channel.

In embodiments, the first aperture is a threaded aperture.

In embodiments, the first portion comprises a first aperture and a linear force element extends between the first aperture and the steering assembly.

In embodiments, the first portion comprises a mounting portion configured to receive an accessory.

In embodiments, the second portion is operably coupled to the ground engaging member only through the first portion.

In yet another embodiment of the present disclosure, a vehicle is provided. The vehicle comprises a ground engaging member, a frame supported by the ground engaging member, and a spindle assembly coupled between the ground engaging member and the frame. The spindle assembly comprises a first spindle member and a second spindle member. The first spindle member comprises a first spindle mounting portion configured to couple to the ground engaging member, a first face extending along a first plane and a second face extending along a second plane. Further, the second face is longitudinally separated from the first face. The second spindle member comprises a second spindle mounting portion extending between the first mounting face and the second mounting face. The second spindle mounting portion comprising a third mounting face configured to align with the first mounting face and a fourth mounting face configured to align with the second mounting face.

In embodiments, a first fastener is configured to extend generally longitudinally through the first mounting face and the third mounting face.

In embodiments, a second fastener is configured to extend generally longitudinally through the second mounting face and the fourth mounting face.

In embodiments, the snow vehicle further comprises a steering assembly, and the steering assembly is coupled between the spindle assembly and the frame.

In embodiments, the second mounting face is positioned vertically lower than the first mounting face.

In embodiments, the second mounting face is positioned longitudinally rearward of the first mounting face.

In embodiments, a first fastener is configured to extend generally longitudinally through the first mounting face, second mounting face, third mounting face, and fourth mounting face.

In embodiments, the frame comprises a fork tube, and a collar is coupled between the second spindle portion and the fork tube.

### BRIEF DESCRIPTION OF THE DRAWINGS

FIG. 1 is a side view of a snow bike of the present disclosure;

FIG. 2 is a perspective view of a ski mount assembly coupled to fork tubes of the snow bike of FIG. 1;

FIG. 3 is a side view of the ski mount assembly of FIG. 2;

FIG. 4 is an exploded view of the ski mount assembly of FIG. 2;

FIG. 5 is a perspective view of the ski mount assembly of FIG. 2;

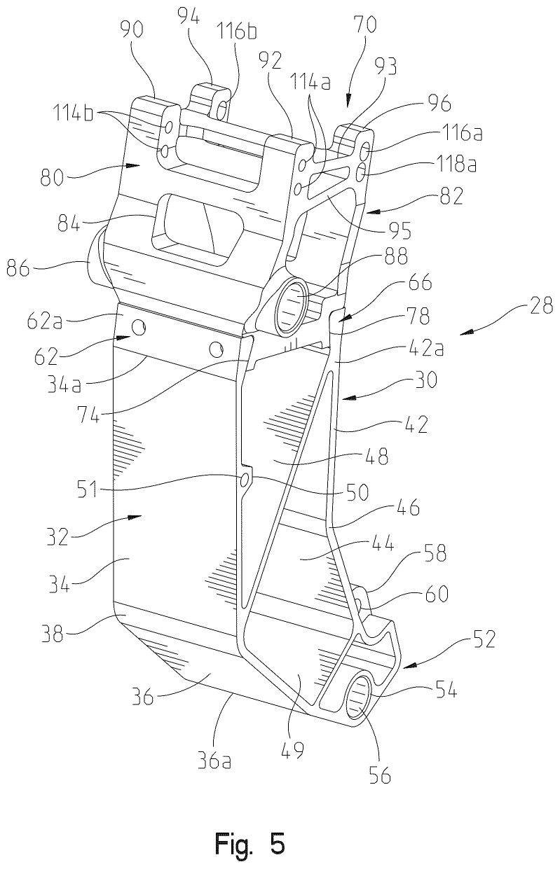

FIG. 6 is an exploded view of the ski mount assembly of FIG. 2;

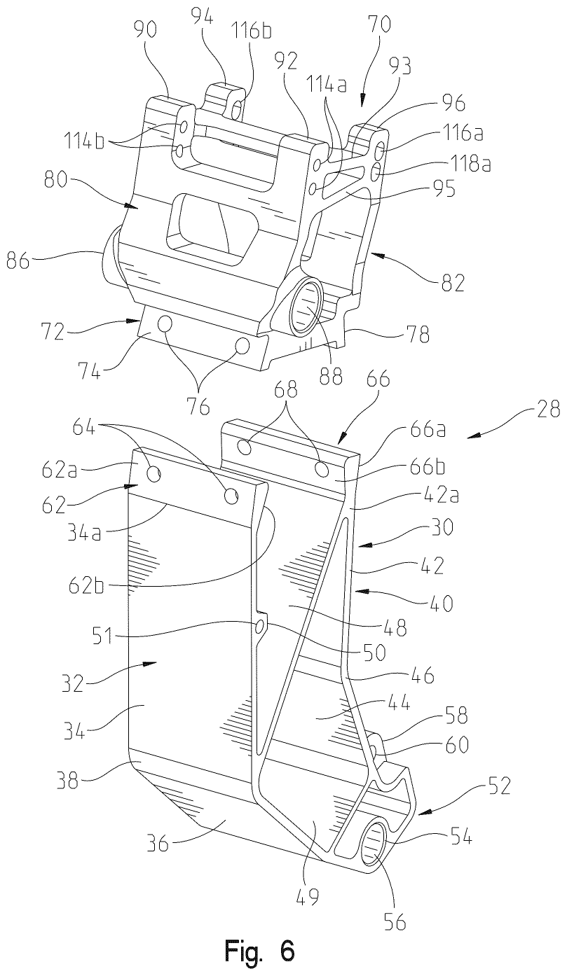

FIG. 7 is a section view of the ski mount assembly of FIG. 2 showing the fork tubes in a first position, taken along line 7-7 of FIG. 2;

FIG. 8 is a section view of the ski mount assembly of FIG. 2 showing the fork tubes in a second position, taken along line 8-8 of FIG. 2; and

FIG. 9 is a diagrammatic side view of the ski mount assembly of FIG. 2 showing multiple positions of a collar.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

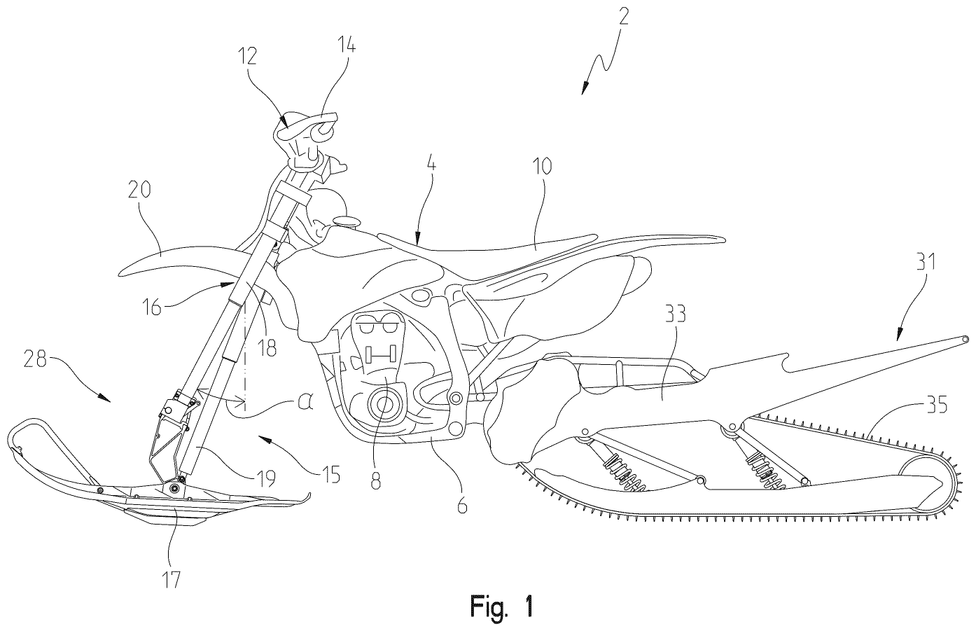

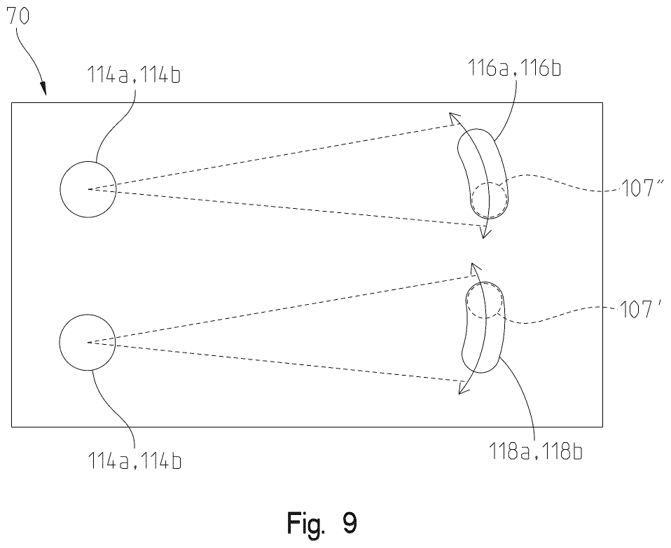

With reference to FIG. 1, one example of a snow bike is shown generally at 2. Snow bike 2 is illustratively shown as comprised of at least portions of a dirt bike 4 when the front and rear wheels thereof are removed; however, in other embodiments, snow bike 2 may be a purpose-built snow bike originally manufactured as such and not assembled as part of dirt bike 4. Snow bike 2 includes a frame assembly 6, a powertrain assembly 8, a driveline assembly 24 (FIG. 9), a seat 10, a steering assembly 12 including handlebars 14, a front suspension assembly 15, and a rear suspension assembly 31. Front suspension assembly 15 is, in part, defined by the existing front fork assembly 18 of dirt bike 4, namely at least left front fork tube or leg 18L and right front fork tube or leg 18R. A front fender 20 of dirt bike 4 may be positioned between front forks 18L, 18R.

In one embodiment, snow bike 2 may be generally assembled when the front wheel of dirt bike 4 is removed and replaced with a front ski mount assembly 28 which couples to front forks 18, as discussed herein. The rear wheel of dirt bike 4 is removed and is replaced with a rear suspension assembly 31 which includes at least a tunnel 33 and a track 35. Rear suspension assembly 31 may be operably coupled to at least powertrain assembly 8 through a driveline assembly (not shown). Rear suspension assembly 31 and other components of snow bike 2 may be similar to those disclosed in U.S. Provisional Patent Application Ser. No. 63/330,968, filed Apr. 14, 2022; U.S. patent application Ser. No. 17/144,820, filed Jan. 8, 2021; U.S. patent application Ser. No. 17/115,259, filed Dec. 8, 2020; U.S. Pat. No. 8,910,738, issued Dec. 16, 2014; U.S. Pat. No. 9,873,485, issued Jan. 23, 2018; U.S. Pat. No. 9,988,067, issued Jun. 5, 2018, and U.S. Pat. No. 10,899,415, issued Jan. 26, 2021; the subject matter of which are expressly incorporated herein by reference. Alternatively, snow bike 2 may be originally assembled with front ski mount assembly 28 and rear suspension assembly 31.

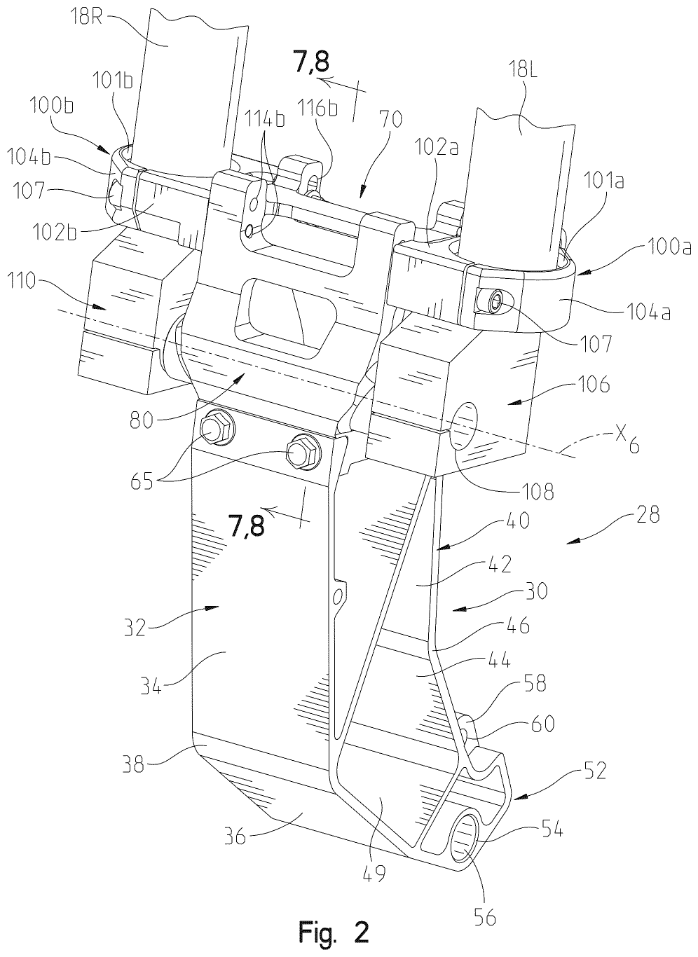

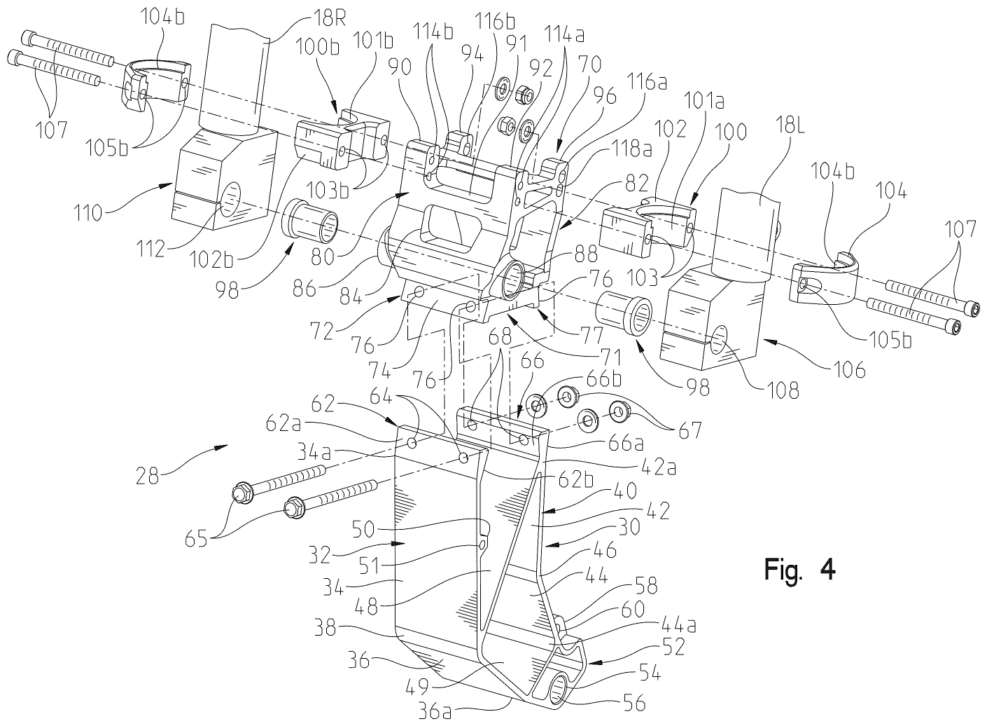

Referring now to FIGS. 2-4, front ski mount assembly 28, or spindle assembly 28, comprises a first spindle portion 30, or lower portion 30, and a second spindle portion 70, or upper portion 70. First portion 30 is generally coupled to a ground-engaging member such as a ski 17. Ground engaging member 17 may also be a wheel, track, or another ground engaging member. Lower portion 30 comprises a front wall 32, a rear wall 40, and a support wall 48 extending between front wall 32 and rear wall 40. Front wall 32 generally comprises an upper portion 34, a lower portion 36, and a bend 38. Upper portion 34 extends between an upper extent 34a and bend 38. In embodiments, upper portion 34 is generally vertical. Further, lower portion 36 extends generally downwardly and rearwardly from bend 38. Rear wall 40 generally comprises an upper portion 42, a lower portion 44, and a bend 46. Upper portion 42 extend between an upper extent 42a and bend 46. In embodiments, upper portion 42 is generally vertical. Further, lower portion 44 extends generally downwardly and rearwardly from bend 38. Support wall 48 extends generally rearwardly and upwardly from bend 38 to upper extent 42a.

Front wall 32 also defines a front projection 62, or mounting portion 62, and a rear projection 66, or mounting portion 66. Front projection 62 extends upwardly from upper portion 34 of front wall 32 and defines an outer face 62a, or front face 62a and an inner face 62b, or rear face 62b. Front projection 62 defines a pair of apertures 64 extending through front face 62a and rear face 62b. Rear projection 66 extends upwardly from upper portion 42 of rear wall 40 and defines an outer face 66a, or rear face 66a and an inner face 66b, or front face 66b. Rear projection 66 defines a pair of apertures 68 extending through front face 66b and rear face 66a. In embodiments, rear projection 66 is longitudinally spaced from front projection 62 and rear face 62b of front projection is longitudinally spaced from front face 66b of rear projection 66.

Lower portion 36 extends downwardly to a joint 36a and lower portion 44 extends downwardly to a joint 44a. A wall 49 extends between joint 36a and joint 44a. A lower frame extension 52 extends downwardly from wall 49 and comprises an annular wall 54 within lower frame extension 52. Further, lower frame extension 52 defines an aperture 56. In embodiments, a rod (e.g., a fastener) is configured to extend through aperture 56 and a receiving aperture (not shown) on ski 17. That is, first spindle portion 30 is coupled to ski 17 at lower frame extension 52 by a rod extending through aperture 56. Lower frame extension 52 defines an arcuate surface 53, and an eyelet wall 58 is supported between arcuate surface 53 and lower portion 44 and eyelet 58 defines an aperture 60. In embodiments, aperture 60 is a mounting aperture and a shock absorber 19 (FIG. 1) extends between mounting aperture 60 and an upper portion (not shown) of fork assembly 18 or steering assembly 12. Shock absorber 19 may be any linear force element, such as an air-based shock absorber, oil-based shock absorber, or another type of shock absorber.

First portion 30 also includes an eyelet 50 positioned on an inner, or rear surface, of upper portion 34, and eyelet 50 defines an aperture 51 which extends generally laterally, parallel to a surface of upper portion 34. In embodiments, eyelet 50 and aperture 51 are configured to receive an accessory such as a trim panel, a cover, a scraper, a shield, a light, or another accessory.

Still referring to FIGS. 2-4, second portion 70 comprises a base portion 71 comprising a first leg 72, or front leg 72, and a second leg 77, or rear leg 77. First leg 72 generally comprises a front face 74 defining a pair of apertures 76. Second leg 77 generally comprises a rear face 78 defining a pair of apertures (not shown) that are generally coaxial to apertures 76. A first wall 80 extends upwardly from base portion 71 generally above first leg 72. First wall 80 defines a first aperture 84, a first arm 90 and a second arm 92. Illustratively, first arm 90 is a right arm and second arm 92 is a left arm. First wall 80 defines an annular channel 87 configured to receive a bushing 86 defining an aperture 88. Annular channel 87 is positioned on a rearward face 80a of first wall 80.

In embodiments, first aperture 84 is configured to receive an accessory, such as a shield, a cover, a trim panel, a scraper, a light, or another accessory.

First arm 90 is separated from second arm 92 by a channel 91. In embodiments, channel 91 is generally a U-shaped channel. First arm 90 defines a pair of vertically separated apertures 114b, and second arm 92 defines a pair of vertically separated apertures 114a. In embodiments, apertures 114a and apertures 114b extend generally laterally and are generally coaxial. In embodiments, each of apertures 114a, 114b are threaded apertures.

A second wall 82 extends upwardly from base portion 71 generally above second leg 77. Second wall 82 includes a third arm 94 and a fourth arm 96. Illustratively, third arm 94 is a right arm and fourth arm 96 is a left arm. Third arm 94 defines a first aperture 116b, or channel 116b vertically separated from a second aperture 118b, or second channel 118b and fourth arm 96 defines a first aperture 116a, or first channel 116a vertically separated from a second aperture 118a, or second channel 118a. Apertures 116a, 116b each extend generally laterally and are generally coaxial, and apertures 118a, 118b each extend generally laterally and are generally coaxial.

In embodiments, a first bridge 93 and a second bridge 95 are configured to couple between first wall 80 and second wall 82. In embodiments, first bridge 93 and second bridge 95 are configured to extend between each of first arm 90, second arm 92, third arm 94, and fourth arm 96. First bridge 93 and second bridge 95 are configured to support and increase the rigidity of second portion 70.

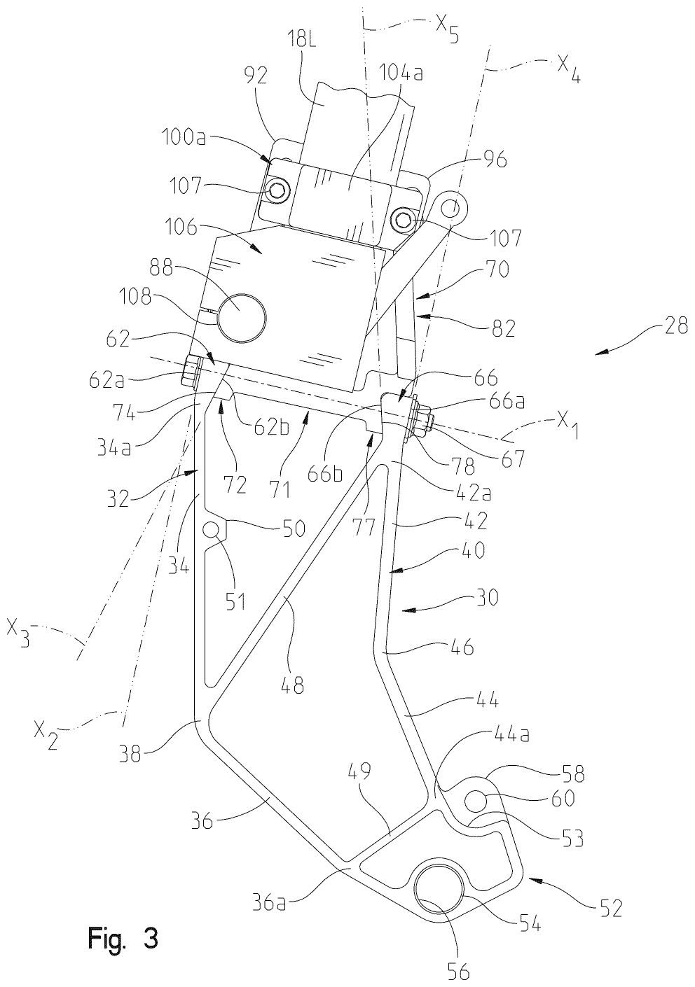

Referring to FIG. 3, first portion 30 is configured to couple with second portion 70. Illustratively, base portion 71 is configured to couple with each of front projection 62 and rear projection 66. That is, front face 74 of first leg 72 is configured to mate with inner face 62b of front projection 62 and rear face 78 of second leg 77 is configured to mate with inner face 66b of rear projection 66. As base portion 71 couples with each of front projection 62 and rear projection 66, each of apertures 64, 76, 68, and apertures (not shown) in second leg 77 are aligned such that a pair of fasteners 65 extend generally longitudinally through the apertures to couple first portion 30 and second portion 70. In embodiments, at least a portion of the interface between rear face 78 and inner face 66b is positioned vertically lower than at least a portion of the interface between front face 74 and inner face 62b.

Still referring to FIG. 3, face 74 and face 62b interface along a plane extending along an axis X3, and face 78 and face 66b interface along a plane extending along an axis X5. Further, fastener 65 (e.g., a bolt) includes a corresponding fastening component 67 (e.g., a nut) and fastener 65 interfaces with face 62a along a plane extending along an axis X2 and nut 67 interfaces with face 66a along a plane extending along an axis X4. Illustratively, axis X2 and axis X4 are generally parallel and perpendicular to axis X1. Further, each of axes X3, X5 are oblique relative to each other and axis X1 (illustratively non-parallel to each other and non-perpendicular to axis X1). The interface between first leg 72 and front projection 62 and the interface between second leg 77 and rear projection 66 allow each of the first portion 30 and second portion 70 to be keyed to each other. Further, a shear plane of the fastener 65 is generally parallel to each of axes X2, X4 and axis X3 defines a shear plane between inner face 62b and front face 74 while axis X5 defines a shear plane between inner face 66b and rear face 78. That is, the shear plane of the fastener 65 (e.g., axes X2, X4) is non-parallel to the shear plane(s) between rear suspension assembly 31 and second portion 70 (e.g., axes X3, X5). Non-parallel shear planes increases the shear strength between rear suspension assembly 31 and second portion 70, which allows for smaller or light materials to be used in the construction of front ski mount assembly 28.

In embodiments, front ski mount assembly 28 includes four fasteners (not shown, e.g., fastener 65) are configured to couple first spindle portion 30 and second spindle portion 70. In embodiments, each aperture 76 in front face 74 and each aperture (not shown) in rear face 78 are threaded, or tapped holes configured to receive a threaded fastener (e.g., screw or bolt). That is, in embodiments, a first fastener (not shown, e.g., fastener 65) is configured to extend through a first aperture 64 of apertures 64 of front projection 62 and a first threaded aperture 76 of apertures 76. A second fastener (not shown, e.g., fastener 65) is configured to extend through a second aperture 64 of apertures 64 of front projection 62 and a second threaded aperture 76 of apertures 76. Further, a third fastener (not shown, e.g., fastener 65) is configured to extend through a first aperture 68 of apertures 68 in rear projection 66 and a first threaded aperture (not shown) in rear face 78. In embodiments, a fourth fastener (not shown, e.g., fastener 65) is configured to extend through a second aperture 68 of apertures 68 of in rear projection 66 and a second threaded aperture (not shown) in rear face 78.

In embodiments, front ski mount assembly 28 is a unitary piece made from a single material. That is, first spindle portion 30 is constructed unitarily with second spindle portion 70 so that front ski mount assembly 28 is a monolithic piece. In embodiments, front ski mount assembly 28 is constructed by an extrusion, stamping, casting, or other manufacturing method.

Referring to FIGS. 2-4, front ski mount assembly 28 is configured to couple to each of fork tubes 18L, 18R. A first coupler 106 is coupled to a bottom of left fork tube 18L and a second coupler 110 is coupled to a bottom of right fork tube 18R. First coupler 106 defines a first aperture 108 and second coupler 110 defines a second aperture 112. Illustratively, when front ski mount assembly 28 is coupled to fork tubes 18L, 18R, each of first aperture 108, aperture 88 and second aperture 112 are aligned and coaxial. A rod (not shown) extends along an axis X6 through each of apertures 108, 112, 88 and allow fork tubes 18L, 18R to rotate relative to front ski mount assembly 28.

Still referring to FIGS. 2-4, a first collar 100a is configured to couple between left fork tube 18L and front ski mount assembly 28. First collar 100a is configured with a first portion 102a and a second portion 104a. A second collar 100b is configured to couple between right fork tube 18R and front ski mount assembly 28 and second collar 100b comprises a first portion 102b and a second portion 104b. In embodiments, each of first collar 100a and second collar 100b are identical, or substantially similar. Collars 100a, 100b each define an inner aperture 101a, 101b, respectively, configured to receive each of fork tubes 18L, 18R, respectively. First portion 102a defines a first portion of inner aperture 101a and second portion 104a defines a second portion of inner aperture 101a. Illustratively, each of first portion 102a and second portion 104a define a semi-circular portion to create inner aperture 101a. First portion 102a defines a pair of apertures 103a and second portion 104a defines a pair of apertures 105a. A pair of fasteners 107 are configured to extend through each of apertures 105a of second portion 104a, 103a of first portion 102a and second portion 70 to couple first collar 100a to second portion 70. First portion 102b defines a first portion of inner aperture 101b and second portion 104b defines a second portion of inner aperture 101b. Illustratively, each of first portion 102b and second portion 104b define a curved (e.g., semi-circular) portion to create inner aperture 101b. First portion 102b defines a pair of apertures 103b and second portion 104b defines a pair of apertures 105b. A pair of fasteners 107 are configured to extend through each of apertures 105b of second portion 104b, 103b of first portion 102b and second portion 70 to couple second collar 100b to second portion 70.

In embodiments, each of fork tubes 18L, 18R are configured to be positioned within apertures 101a, 101b, respectively. That is, each of first portion 102a and second portion 104a are configured to surround leg 18L and a first fastener 107 is configured to extend through apertures 105a of second portion 104a, apertures 103a of first portion 102a and vertically separated apertures 114a of second arm 92, and a second fastener 107 is configured to extend through apertures 105a of second portion 104a, apertures 103a of first portion 102a and either of first aperture 116a or second aperture 118a of fourth arm 96. Further, each of first portion 102b and second portion 104b are configured to surround leg 18R and a third fastener 107 is configured to extend through apertures 105b of second portion 104b, apertures 103b of first portion 102b and vertically separated apertures 114b of first arm 90, and a fourth fastener 107 is configured to extend through apertures 105b of second portion 104b, apertures 103b of first portion 102b and either of first aperture 116b or second aperture 118b of third arm 94.

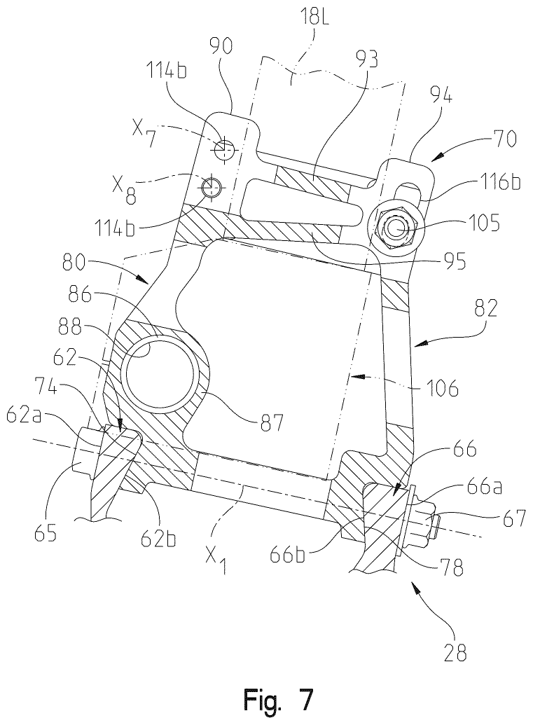

Referring now to FIGS. 7-9, front ski mount assembly 28 includes a plurality of configurations for coupling collars 100a, 100b to second portion 70. In embodiments, collar 100 is coupled to the upper aperture 114 of the pair of apertures 114 and aperture 116. In embodiments, collar 100 is coupled to the lower aperture 114 of the pair of apertures 114 and aperture 118. Referring to FIG. 9, each of aperture 116 and aperture 118 are generally bean-shaped and define separate channels and fastener 107 is configured to move through either channel. That is, fastener 107 extends through collar 100 and aperture 114 to allow collar 100 to rotate about the fastener 107 in aperture 114. Collar 100 is rotatably restricted by fastener 107 extending through collar 100 and either aperture 116 or aperture 118 based upon the arcuate length of either aperture 116, 118. In embodiments, fastener 107 positioned within either aperture 116, 118 may be tightened at any position within aperture 116, 118.

Referring still to FIG. 9, fastener 107 may be positioned along any point of the arcuate path defined by aperture 116, 118. In embodiments, fastener 107 may be positioned at position 107′, or may also be positioned at position 107″.

Referring still to FIG. 9, in embodiments, vertically separated apertures 114a, 114b are positioned longitudinally forwardly of apertures 116a, 116b, 118a, 118b on second spindle portion 70. In embodiments, second spindle portion includes, vertically separated apertures 114a, 114b are positioned longitudinally rearwardly of apertures 116a, 116b, 118a, 118b.

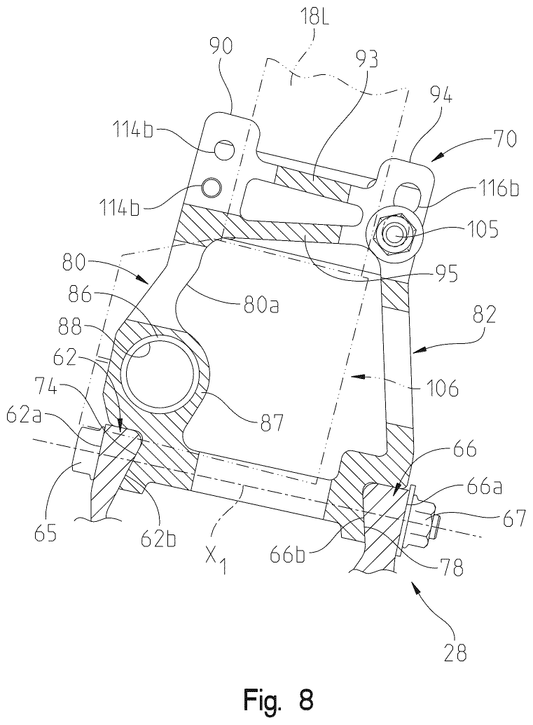

Fork tubes 18L, 18R may extend downwardly at various angles α (FIG. 1) relative to a plane perpendicular to ground (not shown). Snow bike 2 may be configured with various steering assemblies, that is, dirt bike 4 may be manufactured differently by different manufacturers or for different conditions, scenarios, or use cases which may create varying angles α between steering assembly 12 and a plane perpendicular to the ground. Collar 100 may be generally rotated about fastener 107 within upper aperture 114 about an axis X7 to accommodate variously angled fork tubes 18L, 18R. Collar 100 may be generally rotated about fastener 107 within lower aperture 114 about an axis X8 to accommodate variously angled fork tubes 18L, 18R. Further, each fork tube 18L, 18R is coupled to second portion of front ski mount assembly 28 at collar 100 and coupler 106, 110, respectively. Each of fork tubes 18L, 18R is rotatable about axis X6, and as fork tubes 18L, 18R are rotated, each of collars 100a, 100b are configured to rotate about either axis X7 within aperture 116, or axis X8 within aperture 118 to accommodate the rotating fork tubes 18L, 18R. That is, as angle α is varied, or changes, the position of fork tubes 18L, 18R relative to front ski mount assembly 28 changes, and the position of collars 100a, 100b may need to be altered to accommodate the position of fork tubes 18L, 18R. Referring again to FIG. 7-8, in embodiments, the difference in fork tube 18L, 18R position between FIG. 7 and FIG. 8 may indicate a single snow bike 2 with a front steering assembly 12 and front suspension assembly 15 accommodating various loads through front steering assembly 12, or, alternatively, the difference in fork tube 18L, 18R position between FIG. 7 and FIG. 8 may indicate two separate snow bikes 2 configured with different angles α between fork tubes 18L, 18R and a plane perpendicular to the ground. Collars 100a, 100b are configured to rotate relative to second spindle portion 70 to allow fork tubes 18L, 18R with different angles α to properly couple to front ski mount assembly 28.

Referring to FIG. 3, first portion 30 is configured to be a less stiff component than second portion 70 so that first portion 30 may fracture, or break, before second portion 70 when snow bike 2 impacts an object (e.g., unmovable object such as a rock). That is, when snow bike 2 impacts an object, first portion 30 will fracture before second portion 70, and first portion 30 may be replaced instead of the whole front ski mount assembly 28, including second portion 70. Further, when first portion 30 breaks, forces transmitted to fork assembly 18 are reduced, thereby reducing the chance of breaking other parts of front fork assembly 18 or other components of snow bike 18. Replaceability of either first portion 30 or second portion 70 independent of other components of snow bike 2 reduces maintenance costs and maintenance downtime.

In embodiments, rear wall 40 is sized and shaped with a predetermined point of failure, for example, rear wall 40 is configured to bend before front wall 32. That is, rear wall 40 is configured with an appropriate height, width, and depth, and bend 46 is positioned between upper portion 42 and lower portion 44 to promote bending at rear wall 40 before breaking or fracturing front wall 32 or breaking or fracturing second portion 70. In embodiments, front wall 32 is sized and shaped with a predetermined point of failure, for example, front wall 32 is configured to bend before rear wall 40. That is, front wall 32 is configured with an appropriate height, width, and depth, and bend 38 is positioned between upper portion 34 and lower portion 36 to promote bending at front wall 32 before breaking rear wall 40 or breaking second portion 70. In embodiments, first portion 30 is removable from second portion 70 so that only first portion 30 may be replaced when broken. In embodiments, first portion 30 is removable from second portion 70 so that only second portion 70 may be replaced when broken.

In embodiments, the predetermined point of failure is built into first portion 30 so that the predetermined point of failure is broken before any other portion on front ski mount assembly 28. The predetermined point of failure may be created at any point on first portion 30.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

1. A snow vehicle, comprising:
a ground engaging member;
a frame supported by the ground engaging member;
a steering assembly coupled between the frame and the ground engaging member; and
a spindle assembly coupled between the ground engaging member and the steering assembly, the spindle assembly comprising:
a first portion coupled to the ground engaging member; and
a second portion coupled to the steering assembly, and the first portion being removably coupled to the second portion.

2. The snow vehicle of claim 1, wherein the first portion comprises a front frame member and a rear frame member, and the second portion comprises a mounting portion extending between the front frame member and the rear frame member.

3. The snow vehicle of claim 2, wherein a first interface between the front frame member of the first portion and the mounting portion of the second portion extends along a first plane, and a second interface between the rear frame member of the first portion and the mounting portion of the second portion extends along a second plane, and the first plane and the second plane are non-parallel.

4. The snow vehicle of claim 3, further comprising a first fastener extending through the first interface in a generally longitudinal direction of the snow vehicle and a second fastener extending through the second interface in a generally longitudinal direction of the snow vehicle.

5. The snow vehicle of claim 2, wherein the front frame member of the first portion comprises a first bend portion and an intermediate frame member extending between the first bend portion and the rear frame member of the first portion.

6. The snow vehicle of claim 5, wherein the rear frame member of the first portion comprises a second bend portion positioned vertically lower than the intermediate frame member.

7. The snow vehicle of claim 1, wherein the second portion comprises a plurality of apertures, and a collar is configured to couple between the steering assembly and the second portion at the plurality of apertures.

8. The snow vehicle of claim 4, wherein the plurality of apertures includes a first aperture and a channel, wherein the collar is configured to be fixed relative to the first apertures and movable within the channel.

9. The snow vehicle of claim 8, wherein the first aperture is a threaded aperture.

10. The snow vehicle of claim 1, wherein the first portion comprises a first aperture and a linear force element extends between the first aperture and the steering assembly.

11. The snow vehicle of claim 1, wherein the first portion comprises a mounting portion configured to receive an accessory.

12. The snow vehicle of claim 1, wherein the second portion is operably coupled to the ground engaging member only through the first portion.

13. A vehicle comprising:
a ground engaging member;
a frame supported by the ground engaging member;
a spindle assembly coupled between the ground engaging member and the frame, the spindle assembly comprising:
a first spindle member comprising a first spindle mounting portion configured to couple to the ground engaging member, a first face extending along a first plane and a second face extending along a second plane, the second face longitudinally separated from the first face; and
a second spindle member comprising a second spindle mounting portion extending between the first mounting face and the second mounting face, the second spindle mounting portion comprising a third mounting face configured to align with the first mounting face and a fourth mounting face configured to align with the second mounting face.

14. The vehicle of claim 13, wherein a first fastener is configured to extend generally longitudinally through the first mounting face and the third mounting face.

15. The vehicle of claim 14, wherein a second fastener is configured to extend generally longitudinally through the second mounting face and the fourth mounting face.

16. The vehicle of claim 13, further comprising a steering assembly, and the steering assembly is coupled between the spindle assembly and the frame.

17. The vehicle of claim 13, wherein the second mounting face is positioned vertically lower than the first mounting face.

18. The vehicle of claim 17, wherein the second mounting face is positioned longitudinally rearward of the first mounting face.

19. The vehicle of claim 13, wherein a first fastener is configured to extend generally longitudinally through the first mounting face, second mounting face, third mounting face, and fourth mounting face.

20. The vehicle of claim 13, wherein the frame comprises a fork tube, and a collar is coupled between the second spindle portion and the fork tube.
